(19) United States
(12) Patent Application Publication
(10) Pub. No.: US 2006/0227675 A1
(43) Pub. Date: Oct. 12, 2006

(54) Wetsuit with integrated pocket for audio/video device

(76) Inventor: Lance Fried, San Diego, CA (US)

Correspondence Address: STETINA BRUNDA GARRED & BRUCKER, 75 ENTERPRISE, SUITE 250, ALISO VIEJO, CA, 92656, US

(21) Appl. No.: 11/429,326

(22) Filed: May 5, 2006

Related U.S. Application Data
(63) Continuation-in-part of application No. 11/222,163, filed on Sep. 8, 2005.
(63) Continuation-in-part of application No. 11/247,651, filed on Oct. 11, 2005.
(60) Provisional application No. 60/608,856, filed on Sep. 10, 2004.
(60) Provisional application No. 60/621,336, filed on Oct. 22, 2004.

(51) Int. Cl. G11B 21/08

(52) U.S. Cl. 369/30.85

(57) ABSTRACT

A wetsuit with an integrated audio/video device pocket is provided herein. The audio/video device pocket may be sewn to a base layer of the wetsuit at a deltoid portion of the base layer. The audio/video device pocket may be sized and configured to receive the audio/video device. A remote control unit pocket may be attached to a forearm portion of the base layer. The position of the remote control unit pocket may be ergonomically optimal such that the wearer of the wetsuit may easily manipulate the audio/video device via the remote control unit.

### CROSS-REFERENCE TO RELATED APPLICATIONS

This application is a continuation in part of application Ser. No. 11/222,163, filed Sep. 8, 2005, which claims the benefits of provisional application Ser. No. 60/608,856, filed Sep. 10, 2004, the entire contents of which are expressly incorporated herein by reference. Also, this application is a continuation in part of application Ser. No. 11/247,651, filed Oct. 11, 2005, which claims the benefits of provisional application Ser. No. 60/621,336, the entire contents of which are expressly incorporated herein by reference.

### STATEMENT RE: FEDERALLY SPONSORED RESEARCH/DEVELOPMENT

Not Applicable

### BACKGROUND

The present invention relates generally to integrated water, active and action sport clothing products/accessories and audio/video devices such that the wearer of the clothing products and accessories may listen to and/or watch his/her favorite music or video content while engaging in a sporting activity.

Active people such as hikers, surfers, snowboarders and the like enjoy listening to music while engaging in their respective activities. For example, while the hiker hikes up a mountain trail, the hiker may listen to his/her favorite music. To this end, the hiker may wear a backpack. In the backpack, the hiker may place his/her audio/video device in the backpack and route an earphone wire out of the backpack. The hiker inserts an earpiece into his/her ear to listen to music or other audio content played by the audio/video device. Unfortunately, such setup is cumbersome and not user friendly because the hiker must remove and unzip his/her backpack to change songs and/or turn the audio/video device off. Moreover, if the hiker wants to view video content, then the hiker is unable to view any video content stored on his/her video device because the audio/video device is hidden in his/her backpack.

Similarly, surfers enjoy listening to their favorite music while surfing. Surfers may place a waterproof audio device into his/her pocket and route a wire of an earphone to his/her ears. Unfortunately, the surfer must wear a wetsuit over his/her shorts which may impair the warming function of the wetsuit and detract from the comfort of the wetsuit. Also, the surfer is unable to operate the audio/video device while surfing because the audio/video device is inside the wetsuit and inaccessible to the surfer. One type of waterproof audio device is an mp3 player is disclosed in U.S. patent application Ser. No. 11/222,163, filed Sep. 8, 2005.

Accordingly, there is a need in the art for an improved sport clothing product/accessory and audio/video device such that the participant may listen to his/her favorite audio content or view his/her favorite video content while engaging in a physical activity.

### BRIEF SUMMARY

Various aspects of a wetsuit with integrated audio/video device pocket discussed herein address the needs discussed above, discussed below and those that are known in the art.

The wetsuit with integrated pocket may comprise a base layer. The base layer may be fabricated from neoprene or other type of wetsuit material. A pocket or pouch may be sewn onto an exterior surface of the base layer. Preferably, the pocket or pouch may be sewn to a deltoid portion of the base layer. The pocket may have an entrance/exit opening for inserting or removing the audio/video device. A flap may cover the entrance/exit opening to securely hold the audio/video device in the audio/video device pocket. Also, the audio/video device may snugly fit into the audio/video device pocket to securely hold the audio/video device in the audio/video device pocket. The pocket may also have button openings aligned to buttons of the audio/video device when the audio/video device is inserted into the pocket or pouch. In this manner, the user may operate the audio/video device by feeling and depressing buttons exposed through the button openings of the pocket or pouch. An earphone may be attached to the audio/video device such that audio content played on the audio/video device may be heard through an earpiece of the earphone. To listen to the audio content, the surfer may insert the earpiece into his/her ear.

In another aspect of the wetsuit with integrated audio/video device pocket, a remote control unit pocket may be formed on a forearm portion of the base layer. The remote control unit pocket may be sized and configured to receive a remote control unit that may operate the audio/video device. The remote control unit pocket may have pouches to individually receive buttons of the remote control unit. Alternatively, the remote control unit pocket may be a single pouch sized and configured to receive the remote control unit. Buttons of the remote control unit may be exposed through buttons openings formed through the remote control unit pocket. A remote control unit wire may be in electrical communication with the remote control unit. The remote control unit wire may have a jack receiveable into a receiver of the audio/video device. When the jack of the remote control unit wire is connected to the receiver of the audio/video device, the buttons of the remote control unit are operative to control the audio/video device. In this manner, the user may conveniently operate the audio/video device located at the deltoid of the user by manipulating buttons at the forearm of the user. It is contemplated that the remote control unit pocket may be positioned adjacent to any portion of the base layer depending on the sporting activity, preference of the wearer, or other factors. It is also contemplated that the buttons of the remote control unit may be weaved into the base layer of the wetsuit/clothing product. Also, the remote control unit wire may be embedded into the base layer.

In another aspect of the wetsuit, surfers may view his/her favorite visual content while waiting to catch the next wave. In particular, the audio/video device pocket may be attached to the forearm portion of the base layer. The pocket may have a monitor viewing portion which may be fabricated from a clear material. The monitor viewing portion is aligned to a display of the audio/video device when the audio/video device is inserted into the audio/video device pocket. In this manner, the surfer or user may turn his/her wrist to conveniently view his/her favorite visual content on the display of the audio/video device while surfing.

In another aspect of the wetsuit, the wire of the remote control unit and/or a wire of an earphone may be removeably attachable to the base layer of the wetsuit. By way of example and not limitation, wire conduits may be formed on the exterior or interior surfaces of the base layer. To attach the remote control wire to the base layer, a wire conduit may extend between the remote control unit pouch and the audio/video device pouch for housing the remote control unit wire. Additionally, wire conduits may be formed on the exterior or interior surfaces of the base layer that extend between the audio/video device pouch and portions of the base layer adjacent the left and right ears of the wearer for housing the earphone wire. The wire conduits may be formed by attaching strips of hooks to the exterior or interior surfaces of the base layer. Strips of loops may be pivotally attached to edges of the strips of hooks such that the strips of loops may be pivoted onto the strips of hooks to close the wire conduits. The wires of the remote control unit and/or an earphone may be disposed within the wire conduits (i.e., between the strips of hooks and loops) to secure such wires to the base layer.

Alternatively, the wires of the remote control unit and/or the earphone may be embedded into the base layer such that the wetsuit is a pre-wired clothing product for the audio/video device. By way of example and not limitation, a strip of cover layer may extend between the audio/video device pocket and the remote control unit pouch. The remote control unit wire may be disposed between the strip of cover layer and the base layer. The base layer, remote control unit wire and the strip of cover layer may be bonded to each other such as through adhering, hot melting, and sewing. The earphone wire may also be embedded to the base layer in the same manner that the remote control unit wire is embeddable to the base layer.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a surfer wearing a wetsuit with integrated audio/video device pocket such that the surfer may listen to his/her favorite music and/or watch his/her favorite video content while engaging in the surfing activity or waiting to catch a wave;

FIG. 2 is an exploded view of the wetsuit with integrated audio/video device pocket and the audio/video device and an earphone;

FIG. 3 is a front view of a wetsuit with integrated audio/video device pocket and a remote control unit pocket with the audio/video device and the remote control unit contained within their respective pockets;

FIG. 4 is a front view of the wetsuit with integrated audio/video device pocket and a remote control unit pocket sized and configured to receive a credit card sized remote control unit;

FIG. 4A is an enlarged exploded view of the remote control unit pocket and the credit card sized remote control unit shown in FIG. 4;

FIG. 5 is a front view of wetsuit with the audio/video device attached to a forearm portion of the base layer such that the surfer may comfortably view video content while surfing;

FIG. 6 is a rear view of a wetsuit with the audio/video device attached to an interior surface of the base layer of the wetsuit;

FIG. 7 is a front view of the wetsuit shown in FIG. 6 with a remote control unit and corresponding remote control unit pouch attached to the forearm portion of the base layer;

FIG. 8 is a front view of the wetsuit with wire conduits formed on the base layer to secure the wires of the remote control unit and the earphone to the base layer;

FIG. 8A is a cross section of the wire conduit shown in FIG. 8 wherein the wire is removeably engageable to the base layer via strips of hooks and loops;

FIG. 9 is a front view of the wetsuit wherein wires of the remote control unit and the earphone are embedded into the base layer;

FIG. 9A is a cross section of the wire embedded into the base layer shown in FIG. 9;

FIG. 10 is a schematic diagram of the audio/video device; and

FIG. 11 is an exploded perspective of the audio/video device.

### DETAILED DESCRIPTION

As used herein, the definition of waterproof may include water resistant.

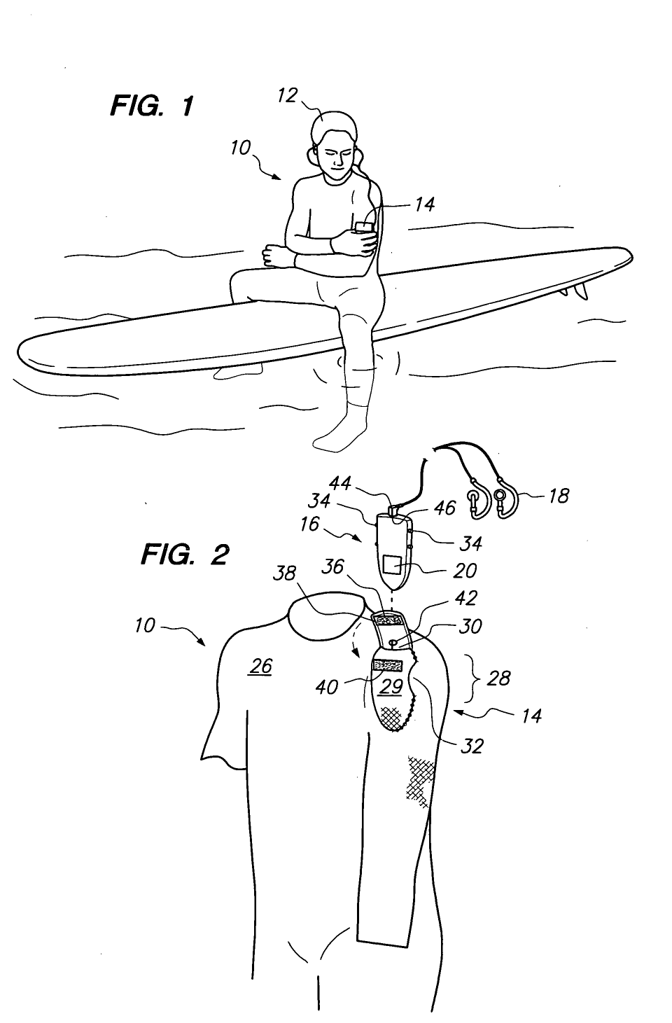

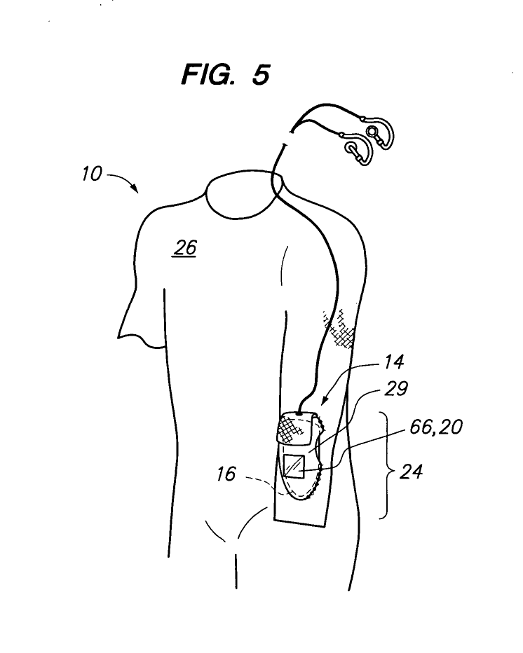

Referring now to the drawings which are for the purpose of illustrating a wetsuit 10 and an integrated audio/video device pocket 14 and not for the purpose of limiting the same, FIG. 1 is an illustration of a surfer 12 wearing the wetsuit 10 with integrated audio/video device pocket 14. The wetsuit 10 provides warmth to the wearer. Simultaneously, the integrated audio/video device pocket 14 of the wetsuit 10 holds an audio/video device 16 (see FIG. 2). The audio/video device 16 may be waterproof and capable of transmitting an audio signal to an earpiece 18 (see FIG. 2) worn by the wearer. Also, the audio/video device 16 may have a monitor 20 (see FIGS. 2 and 5) for displaying video content. In this manner, the surfer 12 may enjoy his or her favorite music or video content while engaging in the surfing activity.

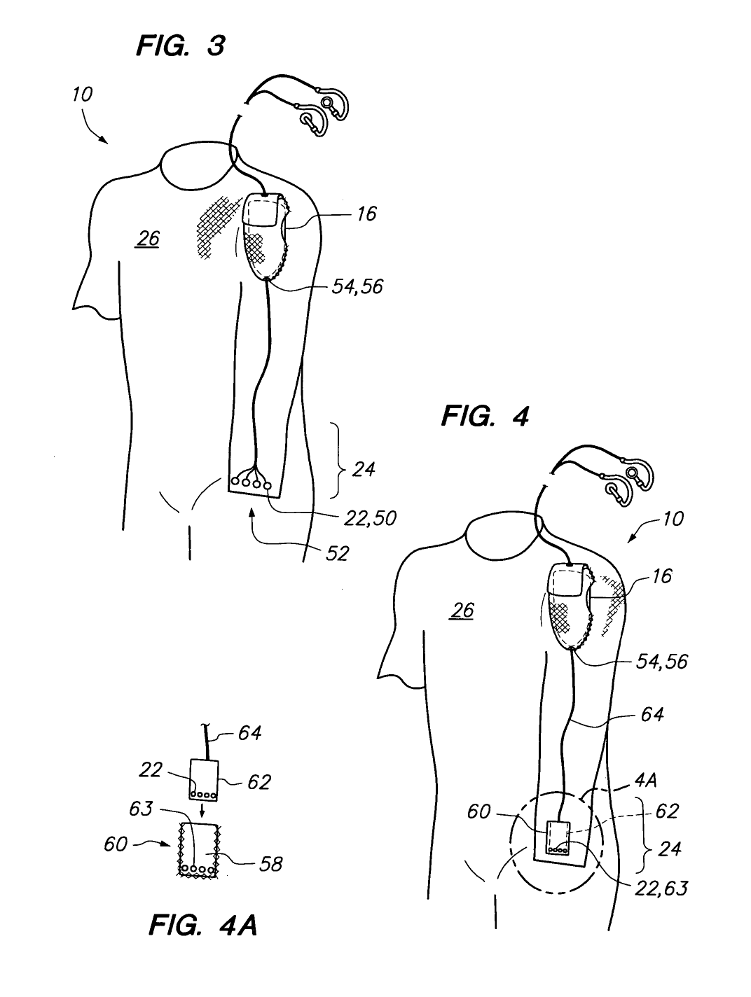

The wetsuit 10 described herein permits the surfer 12 to listen to or watch his/her favorite music or video content without impeding or restricting the surfer's required movement to participate in the surfing activity. For example, when the surfer 12 attempts to catch a wave, the surfer 12 must vigorously paddle with his/her arms. The wetsuit 10 with integrated audio/video device pocket 14 permits the surfer 12 to vigorously paddle to catch the wave without an earphone wire or the audio/video device 16 itself restricting the surfer's movement. Additionally, the wetsuit 10 may have remote control buttons 22 (see FIGS. 3, 4 and 7) near or approximate a forearm portion 24 (see FIGS. 3, 4 and 7) of the wetsuit 10 such that the user may operate the audio/video device 16 more comfortably.

Although the wetsuit 10 with integrated audio/video device pocket 14 is described in reference to a surfing activity, it is also contemplated that the various aspects of the present invention may be employed and embodied in relation to other sports such as swimming, parachuting, road biking, mountain biking, hiking, etc. By way of example and not limitation, the audio/video device pocket 14 may be attached to a parachuting jumpsuit. It is also contemplated that the audio/video device pocket may be attached to other accessories such as a rash guard. Also, the audio/video device 16 may be an audio device for playing audio content, a video device for playing visual content along with audio content, or a combination audio/video device 16 for playing audio content or for playing visual content along with audio content.

Referring now to FIG. 2, the wetsuit 10 of a first embodiment may comprise a base layer 26. The audio/video device pouch 14 may be attached to the base layer 26 at a deltoid portion 28 of the base layer 26. The pouch 14 may comprise an upper layer 29. As shown in FIG. 2, an outer periphery of the upper layer 29 may be selectively joined or sewn to the deltoid portion 28 of the base layer 26 to form an entrance/exit opening 30 and button openings 32 about the outer periphery of the upper layer 29. The upper layer 29 may be fabricated from a stretchable material (e.g., spandex, wetsuit material, neoprene, lycra, etc.). The entrance/exit opening 30 may be smaller than an outer circumference of the audio/video device 16. To insert the audio/video device 16 into the pouch 14, the entrance/exit opening 30 may be stretched. The audio/video device 16 may then be inserted into the pouch 14 through the entrance/exit opening 30. Once the audio/video device 16 has completely entered the pouch 14, the entrance/exit opening 30 may be un-stretched. The buttons 34 of the audio/video device 16 may be aligned to the left and right button openings 32 when the audio/video device 16 is disposed in the pouch 14.

To securely hold the audio/video device 16 in the pouch 14, a flap 36 may cover the entrance/exit opening 30 and be secured to the upper layer 29. In particular, a proximal end of the flap 36 may have a strip of hooks 38 which engages a strip of loops 40 attached to the outer surface of the upper layer 29. A distal end of the flap 36 may be sewn to the base layer 26 adjacent the entrance/exit opening 30. An earphone jack hole 42 may be formed through the flap 36 such that an earphone jack 44 may be inserted through the earphone jack hole 42 and received into a jack receiver 46 of the audio/video device 16.

In use, the above described wetsuit 10 with integrated audio/video device pocket 14 may be worn by a surfer 12. The surfer 12 may insert an audio/video device 16 in the pouch 14. At this point, the buttons 34 are aligned to the button openings 32. The flap 36 may be disposed over the entrance/exit opening 30 and secured to the upper layer 29 via the strip of hooks 38 and strip of loops 40. An earphone jack 44 of an earphone may be received into the earphone jack hole 42 of the flap 36 and into the jack receiver 46 of the audio/video device 16. The surfer 12 may insert the earpiece 18 of the earphone into his/her ear to listen to music or other audio content (e.g., music, how-to audio recordings, self help audio recordings, etc.). The surfer 12 may select different tracks and operate the audio/video device 16 by manipulating the buttons 34 of the audio/video device 16 through the button openings 32.

Referring now to FIG. 3, in a second embodiment of the wetsuit 10, a remote control unit pouch may be formed on the exterior surface of the base layer 26. The remote control unit pouch may be formed on a forearm portion 24 of the base layer 26. As shown in FIG. 3, the remote control unit pocket may be a plurality of pouches 50 formed to individually receive buttons 22 of the remote control unit 52 for operating the audio/video device 16. In use, after the audio/video device 16 is inserted into the audio/video device pouch 14, a remote control unit jack 54 of the remote control unit 52 may be inserted into a jack receiver 56 of the audio/video device 16 at its bottom end. The buttons 22 of the remote control unit 52 may be inserted into the plurality of pouches 50 of the remote control unit pocket. In this manner, the surfer 12 may operate the audio/video device 16 via the buttons 22 of the remote control unit 52. The surfer 12 does not have to reach up near the surfer's deltoid to control the audio/video device 16. Rather, the surfer 12 may comfortably operate the audio/video device 16 with the buttons 22 positioned adjacent the user's forearm.

Referring now to FIGS. 4 and 4A, in a third embodiment of the wetsuit 10 with integrated audio/video device pocket 14, the pouch 60 for the remote control unit 62 may be sized and configured to snugly receive a flexible credit card sized remote control unit 62. In particular, the remote control unit 62 may have a flexible credit card sized base unit with a plurality of buttons 22 (see FIG. 4A) formed thereon. The buttons 22 may be used to control or operate the audio/video device 16. The base unit may have an electrical wire or communication wire 64 which extends out from the base unit. A distal end of the electrical wire 64 may have a remote control unit jack 54 which may be inserted into the remote control unit jack receiver 56 of the audio/video device 16 to electrically connect the audio/video device 16 and the remote control unit 62. The pouch 60 may comprise an upper layer 58 (see FIG. 4A). The outer periphery of the upper layer 58 may be sewn to the exterior surface of the base layer 26, as shown in FIG. 4A. For example, the left, right and bottom sides of the upper layer 58 may be sewn to the base layer 26 while the top side of the upper layer 58 is not sewn to the base layer. The remote control unit 62 may be inserted into the pouch 60 via the opening defined by the top side of the upper layer 58 and the base layer 26. The upper layer 58 may be fabricated from a stretchable material (e.g., spandex, wetsuit material, neoprene, lycra, etc.). Although the remote control unit 62 is described as being a flexible credit card sized remote control unit, it is contemplated that the remote control unit may have other sizes, shapes, rigidity, etc.

In use, the remote control unit 62 may be inserted into the remote control unit pocket 60. There may be a snug fit between the remote control unit 62 and the pocket 60 such that the remote control unit 62 does not come out of the pocket 60 while the surfer is surfing. The buttons 22 of the remote control unit 62 may be aligned to button openings 63 of the remote control unit pocket 60. The jack 54 of the remote control unit 62 may be connected to the remote control unit jack receiver 56 of the audio/video device 16. The surfer 12 may feel and depress the buttons 22 of the remote control unit 62 to control and operate the audio/video device 16.

As used herein, remote control unit may be defined as any sensor, button or unit which may remotely (i.e., without directly contacting the unit) operate the audio/video device 16. As described herein, the button or unit may be sewn into the base layer or made integral with the base layer. Also, the button or unit may be made removeably attachable to the base layer.

Referring now to FIG. 5, in a fourth embodiment of the wetsuit 10 with integrated audio/video device pocket 14, the audio/video device pouch 14 may be attached to the forearm portion 24 of the base layer 26. The audio/video device pouch 14 may additionally have a monitor viewing portion 66 for viewing a monitor 20 of the audio/video device 16. The monitor viewing portion 66 may be fabricated by forming an opening through the upper layer 29. The opening may be sized and configured to match the monitor 20 of the audio/video device 16. When the audio/video device 16 is inserted into the audio/video device pocket 14, the monitor 20 of the audio/video device 16 may be aligned to the monitor viewing portion 66. The opening of the monitor viewing portion 66 may be covered by sewing a clear flexible material (e.g., clear plastic, etc.) to the opening. In particular, an outer periphery of the clear flexible material may be sewn to the inner periphery of the opening. The wearer of the wetsuit 10 may view video content through the monitor viewing portion 66 of the pocket 14 while waiting for the next wave.

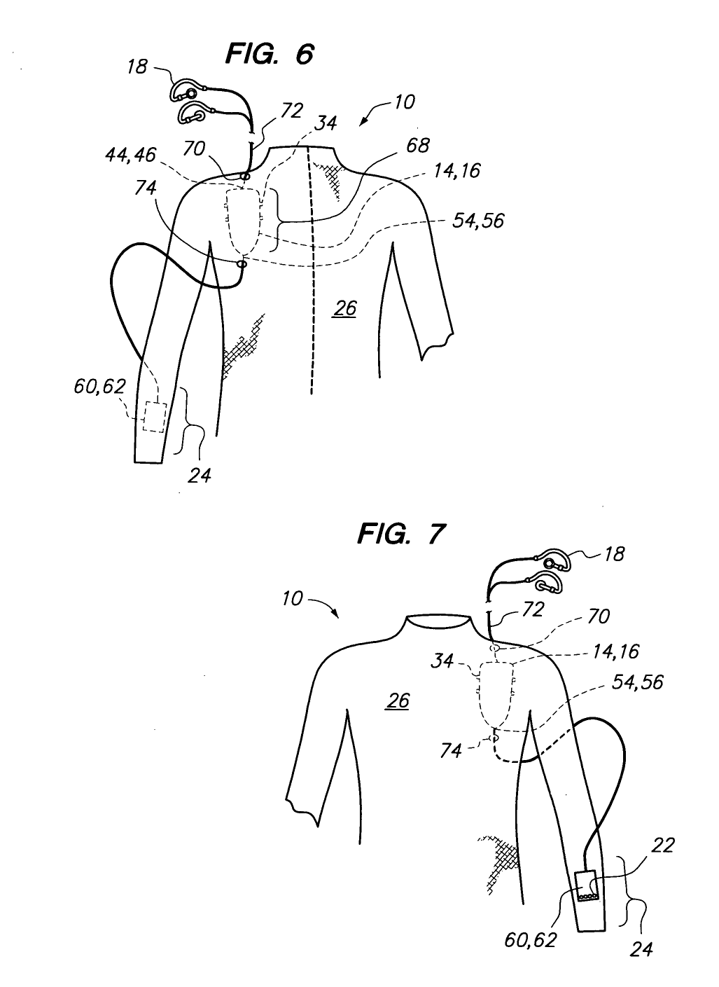

Referring now to FIGS. 6 and 7, in a fifth embodiment of the wetsuit 10 with integrated audio/video device pocket 14, the audio/video device pouch 14 may be attached to an interior surface of the base layer 26. By way of example and not limitation, the pouch 14 may be formed on the interior surface of the base layer 26 by sewing the pouch 14 to the interior surface of the base layer 26. Also, the pouch 14 may be attached to the shoulder blade portion 68 (see FIG. 6) of the base layer 26. Although the fifth embodiment of the wetsuit 10 with integrated audio/video device pocket 14 is described as having the audio/video device pocket 14 attached to the shoulder blade portion 68 of the base layer 26, it is contemplated that the audio/video device pocket 14 may be attached to any portion (e.g., deltoid portion 28, forearm portion 24, or thigh portion, etc.) of the base layer 26.

A first through hole 70 may be formed through the base layer adjacent the upper portion of the pouch 14. The first through hole 70 may be sized and configured to receive an earphone jack 44 and earphone wire 72 of the ear phone. A second through hole 74 may be formed through the base layer 26 adjacent the lower portion of the audio/video device pocket 14. The second through hole 74 may be sized and configured to receive remote control unit jack 54. A remote control unit pocket 60 may be formed on the exterior surface of the forearm portion 24 of the base layer 26. The remote control unit pocket 60 may be sized and configured to receive the remote control unit 62.

In use, after the audio/video device 16 is secured in the audio/video pouch 14 and the flap 36 (optional) is closed over the entrance/exit opening 30, the earphone jack 44 and earphone wire 72 may be inserted through the first through hole 70. The earphone jack 44 may be inserted into and received by the earphone jack receiver 46. The earphone wire 72 extends out of the first through hole 70 and the earpiece 18 may be inserted into the surfer's ear.

The remote control unit 62 may be inserted into the remote control unit pocket 60 and secured therein. The remote control unit jack 54 and wire may be inserted through the second through hole 74. The remote control unit jack 54 may be inserted into the remote control unit jack receiver 56 of the audio/video device 16. In this manner, the surfer 12 may comfortably operate the audio/video device 16 via buttons 22 (see FIG. 4) of the remote control unit 62 instead of reaching into the wetsuit 10 to depress buttons 34 (see FIG. 2) on the audio/video device 16 to operate the audio/video device 16.

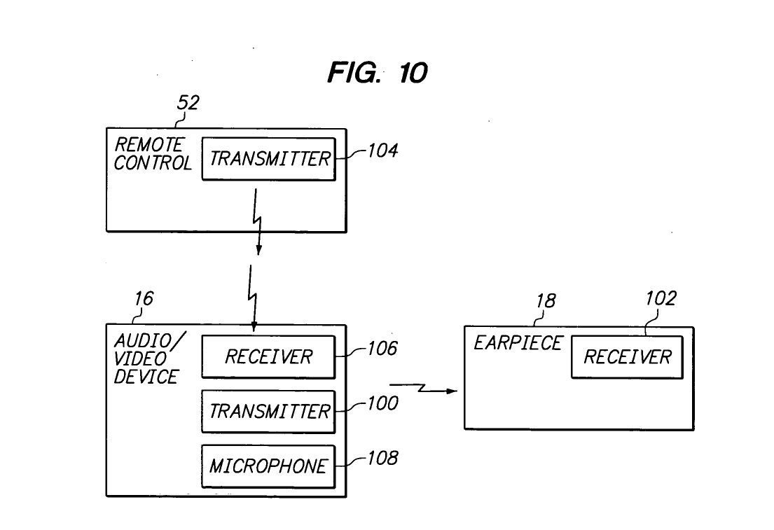

In an aspect of the wetsuit 10 with integrated audio/video device pocket 14, referring to FIG. 10, the audio/video device 16, earphone, and remote control unit may be wireless enabled devices (e.g., wi-fi, Bluetooth, etc.). The wireless feature is further described in U.S. application Ser. No. 11/247,651, the entire content of which is expressly incorporated herein by reference. By way of example and not limitation, the audio/video device 16 may have a transmitter 100 for wirelessly transmitting audio content to the earpiece 18. The earpiece 18 may have a receiver 102 for receiving the transmitted audio content. Additionally, the remote control unit 52 may have a transmitter 104 for wirelessly transmitting control signals to the audio/video device 16. The audio/video device 16 may have a receiver 106 for receiving the transmitted control signal. The control signals are operative to stop, play, fast forward, rewind, play next track, play previous track, etc. the audio/video device 16. It is contemplated that the wireless feature may be employed with the other features discussed herein in addition to or in place of such feature. By way of example and not limitation, the audio/video device 16 may communicate with the remote control unit wirelessly but the audio/video device 16 may communicate with the earpiece via an earphone wire. Conversely, the audio/video device may communicate with the earpiece wirelessly but the remote control unit via a remote control unit wire. Furthermore, the audio/video device may communicate with the earpiece and the remote control unit wirelessly.

Still referring to FIG. 10, in another aspect of the wetsuit 10 with integrated audio/video device pocket 14, the audio/video device 16 may be operated via voice command, as described in U.S. patent application Ser. No. 11/247,651, the entire content of which is expressly incorporated herein by reference. In particular, the audio/video device 16 may have a microphone 108 for receiving spoken commands from the wearer of the wetsuit 10. In use, the wearer 12 may speak “stop” to stop playing the current audio/video content; “play next” to play the next track; “play previous” to play the previous track; “play” to play the current track; etc. When the wearer 10 speaks commands, the microphone 108 of the audio/video device 16 picks up the voice commands and a processor of the device 16 processes the commands to determine which command the wearer 12 has spoken. Once the voice command is processed, the audio/video device 16 carries out the specific voice command. It is contemplated that the voice command feature may be employed with the other features discussed herein in addition to or in place of such feature. By way of example and not limitation, the remote control unit may have a microphone for receiving voice commands. The processing of the voice command may occur on a processor of the remote control unit or may occur on a processor of the audio/video device 16.

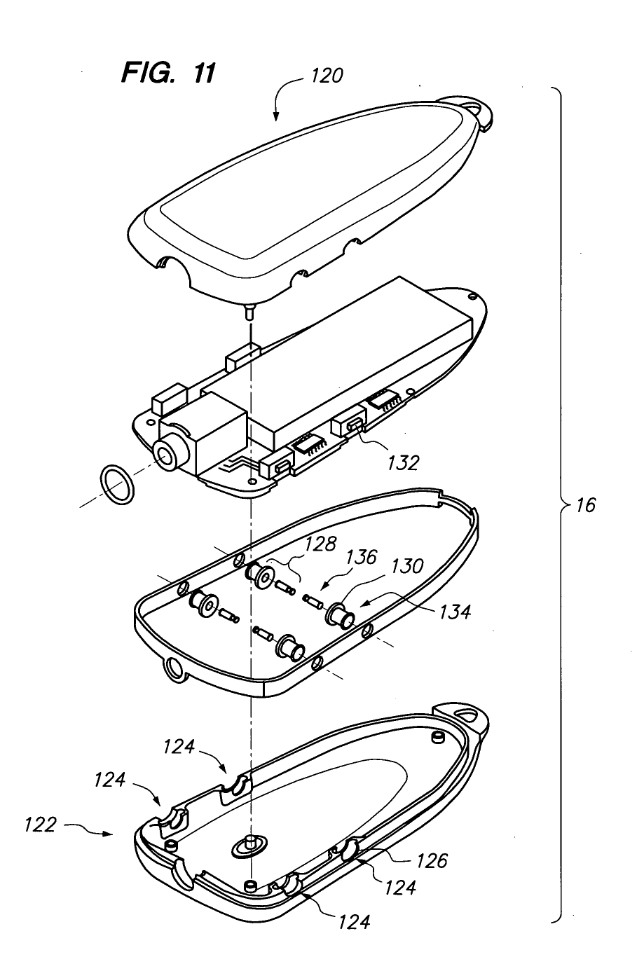

In another aspect of the wetsuit 10 with integrated audio/video device pocket 14, referring now to FIG. 11, the audio/video device 16 may be waterproof, as described in U.S. patent application Ser. No. 11/222,163, the entire content of which is expressly incorporated herein by reference. The audio/video device 16 may comprise an upper housing 120 and a lower housing 122. The housings 120, 122 may form button apertures 124 with rim grooves 126 formed about an inner periphery of the button apertures 124. Buttons 128 are sized and configured to fit within the button apertures 124, and rim portions 130 of the buttons 128 are sized and configured to have a snug fit with the rim grooves 126 such that there is a water tight seal therebetween and the user of the audio/video device 16 may engage in water related activities. The buttons 128 are traverseable between a depressed position which activates switches 132 to control the device 16 and a retracted position to deactivate the switches 132. In particular, the buttons 128 may have a flexible member 134 and a rigid member 136 inserted inside of the flexible member 134. The flexible member 134 provides the water tight seal with the housings 120, 122 and the rigid member 136 activates the switches 132.

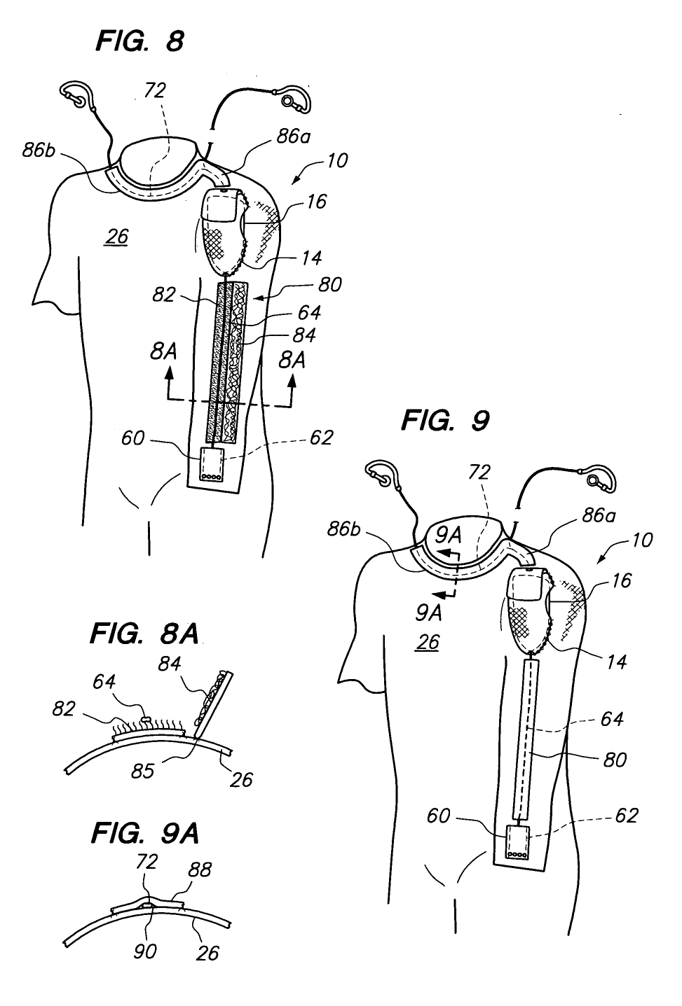

In an aspect of the wetsuit 10 with integrated audio/video device pocket, referring now to FIGS. 8 and 8A, wires 64, 72 of the remote control unit 62 and/or earphone may be engageable to the base layer 26 such that the wires 64, 72 are prevented from swinging around and possibly becoming tangled with the arms, neck and other appendages of the surfer 12 and the surfer's equipment (e.g., board, fins, etc.). Also, the wires 64, 72 of the remote control unit 62 and/or earphone may be removable from the base layer 26 to service the remote control unit 62, audio/video device 16 and/or earphone.

By way of example and not limitation, a wire conduit 80 may be formed between the audio/video device pocket 14 and the remote control unit pocket 60, as shown in FIG. 8. The wire conduit 80 may comprise a strip of hooks 82 and strip of loops 84 (see FIG. 8A). The strip of hooks 82 may be attached (e.g., sewing, adhesive bonding, etc.) to the exterior and/or interior surfaces of the base layer 26 and extend between the audio/video device pocket 14 and the remote control unit pouch 60. The strip of loops 84 may be pivotally attached (e.g., sewing, adhesive bonding, etc.) to the edge of the strip of hooks 82. The strip of loops 84 may pivot about pivot point 85 (see FIG. 8A). The strips of loops 84 may be pivoted onto the strips of hooks 82 to close the wire conduit 80. The remote control unit wire 64 may be disposed within the wire conduit 80 by disengaging the strip of loops 84 from the strip of hooks 82. The wire 64 may be placed on the strip of hooks 82 (see FIG. 8A) and the strip of loops 84 may be placed over the strip of hooks 82 to close the wire conduit 80. If the remote control unit wire 64 is excessively long, then the wire 64 of the remote control unit may be folded upon itself and disposed within the wire conduit 80. The length of the remote control unit wire 64 exposed outside of the wire conduit 80 should be sufficient such that the surfer 12 has a full range of motion for surfing and the remote control unit wire 64 will not become tangled with the surfer 12 or his/her equipment.

Additionally, still referring to FIG. 8, wire conduits 86a, b having the same structure as wire conduit 80 may also be formed on the exterior and/or interior surfaces of the base layer 26. The wire conduits may extend between the audio/video device pocket 14 and a neck portion of the base layer 26. In particular, a first wire conduit 86a may be formed on the exterior and/or interior surfaces of the base layer 26 which extends from the audio/video device pocket 14 to a portion of the base layer 26 adjacent the left ear of the surfer 12. A second wire conduit 86b may be formed on the base layer 26 from the first wire conduit 86a to a portion of the base layer 26 adjacent the right ear of the surfer 12. The earphone wire 72 may be disposed within the first and second wire conduits 86a, b. If the earphone wire 72 is excessively long, then the earphone wire 72 may be folded upon itself and disposed within the wire conduits 86a, b. The length of the earphone wire 72 exposed outside of the wire conduits 86a, b should be sufficient such that the surfer has full range of motion for surfing and the earphone wire 72 will not become tangled with the surfer or his/her equipment.

Alternatively, referring now to FIGS. 9 and 9A, the wire 72 for the earphone may be embedded into the base layer 26. For example, the wire 72 of the earphone may be fixedly attached to the base layer 26. In particular, the wire 72 of the earphone may be disposed between a cover layer 88 and the base layer 26, as shown in FIG. 9A. The cover layer 88 may be attached to the base layer 26 with the wire 72 of the earphone disposed therebetween via methods know in the art such as adhering, sewing, and the like. For example, the earphone wire 72 may be disposed between the cover layer 88 and the base layer 26. The outer periphery of the cover layer 88 may be sewn (see FIG. 9A) to the base layer 26 with the earphone wire disposed between the cover layer 88 and the base layer 26. Additionally, flexible adhesive 90 may be disposed between the cover layer 88 and the base layer 26 and allowed to cure.

Additionally, the remote control unit wire 64 may be embedded into the base layer 26 in a similar fashion as earphone wire 72. The remote control unit wire 64 may extend from the audio/video device pocket 14 to remote control unit pocket 60.

It is also contemplated that the remote control unit pouch, audio/video device pocket 14, wire conduits 80, 86a, b may be attached to the base layer 26 at different positions. For example, the audio/video device pocket 14 may be attached to the exterior surface of the base layer 26 near the throat area, bicep area, tricep area, thigh area, etc. of the wearer of the wetsuit 10. To accommodate the position of the audio/video device pocket 14, the wire conduits 80, 86a, b may be appropriately rerouted to the forearm portion 24 and neck portions of the base layer 26 to secure the remote control unit wire 64 and earphone wire 72 to the base layer 26. It is also contemplated that the audio/video device pocket 14, remote control unit pocket, remote control unit, and/or wire conduits 80, 86a, b may be attached to other sporting activity clothing or sporting activity accessory (e.g., knee pads, face mask, etc.). For example, in rock climbing, the audio/video device pocket 14, remote control unit, and/or wire conduit(s) 80, 86a, b may be attached to the rock climber's harness such that the rock climber may enjoy his/her favorite music or video while rock climbing. In surfing, the audio/video device pocket 14, remote control unit, and/or wire conduit(s) 80, 86a, b may be attached to a rash guard instead of a wet suit. In running, the audio/video device pocket 14, remote control unit, and/or wire conduit(s) 80, 86a, b may be attached to running tights and/or running outfit.

It is also contemplated that the audio/video device 16 may be embedded into the base layer 26 in a similar manner that the wires 64, 72 of the remote control unit and audio/video device 16 are embedded into the base layer 26. For example, the audio/video device 16 may be disposed between a cover layer and the base layer 15. The outer periphery of the cover layer may be joined to the base layer 15. Flexible adhesive may be disposed (e.g., injected, etc.) between the cover layer and the base layer 26 and cured. The buttons 34 of the audio/video device 16, jack receiver 54 for the remote control unit and jack receiver 46 for the earphone may be accessible via openings between the base layer 26 and the cover layer.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A wetsuit for simultaneously warming a wearer and holding an audio/video player, the audio/video player having a plurality of buttons for operating the audio/video player, the audio/video player having an output jack for receiving an earphone jack of an earphone, the wetsuit comprising:
a. a base layer having a body portion, left and right sleeve portions, left and right leg portions wherein the body portion, left and right sleeve portions and left and right leg portions are fabricated as a unitary base layer, the unitary base layer fabricated from wetsuit material; and
b. a pocket attached to the base layer, the pocket sized and configured to receive and secure the audio/video player to the base layer, the pocket having a button opening aligned to the button of the audio player when the audio player is received into the pocket, the pocket having an entrance/exit opening for inserting or removing the audio/video device from the pocket.

2. The wetsuit of claim 1 wherein the left and right sleeve portions are short sleeves.

3. The wetsuit of claim 1 wherein the wetsuit material is neoprene, lined with nylon or contains spandex.

4. The wetsuit of claim 1 wherein the pocket further comprises a closure flap for securing the audio/video player in the pocket.

5. The wetsuit of claim 4 wherein the closure flap defines a closed position and an opened position, the closure flap being maintained in the closed position via strips of hooks and loops.

6. The wetsuit of claim 1 wherein the pocket is positioned on the left sleeve portion such that the wearer may manipulate the buttons of the electronic audio player with his/her right hand.

7. The wetsuit of claim 6 wherein the pocket is attached to a left deltoid portion of the base layer.

8. The wetsuit of claim 1 wherein the audio/video player is a waterproof audio/video device, waterproof mp3 player, or a waterproof electronic music player.

9. A wetsuit for warming a wearer and holding an audio/video player, the audio/video player having a plurality of buttons for operating the audio/video player, the audio/video player having an output jack for receiving an earphone jack of an earphone, the wetsuit comprising:
a. a base layer having a body portion and left and right sleeve portions wherein the body portion and left and right sleeve portions are fabricated to be a unitary base layer, the unitary base layer fabricated from wetsuit material; and
b. a pocket attached to the base layer, the pocket sized and configured to receive and secure the audio/video player to the base layer, the pocket having an entrance/exit opening for inserting or removing the audio/video player from the pocket.

10. The wetsuit of claim 9 wherein the pocket is attached to an inner surface or an outer surface of the base layer.

11. A wetsuit for warming a wearer and holding an audio/video player, the audio/video player having a remote control unit for operating the audio/video player remotely, the wetsuit comprising:
a. a base layer fabricated from wetsuit material;
b. a first pocket attached to the wetsuit clothing article, the first pocket sized and configured to receive the audio/video player and secure the audio/video player to the base layer; and
c. a second pocket attached to the wetsuit clothing article, the second pocket sized and configured to receive the remote control unit and secure the remote control unit to the base layer.

12. The wetsuit of claim 11 wherein the second pocket is positioned on a forearm portion of the base layer.

13. The wetsuit of claim 11 wherein the first pocket is positioned on a deltoid portion of the base layer.

14. An integrated water sport clothing product comprising:
a. a clothing article;
b. an audio/video device pocket attached to the clothing article; and
c. an earphone wire engageable to the clothing article.

15. The product of claim 14 wherein the earphone wire is removeably engageable to the clothing article via a system of strips of loops and hooks.

16. The product of claim 14 wherein the earphone wire is embedded into the clothing article.

17. The product of claim 16 wherein the earphone wire is disposed between a cover layer and a base layer of the article of clothing.

18. An integrated water sport clothing product comprising:
a. a clothing article; and
b. an audio/video device embedded into the clothing article.

19. The product of claim 18 wherein the audio/video device is disposed between a cover layer and a base layer of the clothing article.

20. The product of claim 19 wherein an outer periphery of the cover layer is joined to the base layer.

21. The product of claim 20 further comprising flexible adhesive disposed between the cover layer and the base layer.

22. The product of claim 20 further comprising a remote control unit embedded into the clothing article.

23. The product of claim 22 wherein audio/video device is water proof.

24. The product of claim 22 wherein the remote control unit and the audio/video device are wireless enabled devices.

25. The product of claim 18 wherein the audio/video device further comprises:
a. a microphone for recognizing speech; and
b. a processor for processing the recognized speech and operating the audio/video device based on the recognized speech.
